(19) United States
(12) Patent Application Publication
(10) Pub. No.: US 2023/0337606 A1
(43) Pub. Date: Oct. 26, 2023

(54) INTELLIGENT IRRIGATION SYSTEM

(71) Applicant: Design Simplicity LLC, Irvine, CA (US)

(72) Inventor: Amir Borhani, Irvine, CA (US)

(21) Appl. No.: 17/725,068

(22) Filed: Apr. 20, 2022

(51) Int. Cl. A01G 27/00; G05B 13/02

(52) U.S. Cl. CPC A01G 27/003; G05B 13/0265

(57) ABSTRACT

A system for intelligent irrigation based on moisture-level data acquired from multiple locations. The system includes a processor of an irrigation server connected to a moisture-level sensor and to a water tank control unit over a network; a memory on which are stored machine-readable instructions that when executed by the processor, cause the processor to: acquire a moisture-level data from the moisture-level sensor at a plant location; determine a plant type based on the plant location associated with the moisture-level sensor; process the moisture-level data and the plant type to generate a feature vector; provide the a feature vector to an AI module for generation of an irrigation instruction output; and responsive to the irrigation instruction output received from the AI module, send a command signal to the water tank control unit to turn on a pump for irrigation of the plant location.

### FIELD OF DISCLOSURE

The present disclosure generally relates to irrigation of plants, and more particularly, to an intelligent irrigation system that uses moisture sensors.

### BACKGROUND

Irrigation is the artificial application of water to the soil through various systems of tubes, pumps, and sprays. Irrigation is usually used in areas where rainfall is irregular or dry times or drought is expected. There are many types of irrigation systems, in which water is supplied to the entire field uniformly. Conventional irrigation systems use moisture-level data acquired from the soil. However, existing irrigation system do not provide automated irrigation to various plants based on different moisture-level at individual locations of the plants.

Accordingly, a system and method for intelligent irrigation system that uses moisture-level data for different plants are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter’s scope.

One embodiment of the present disclosure provides a system for intelligent irrigation of plants based on moisture-level data acquired from moisture-level sensors over a network. The system includes a processor of an irrigation server connected to at least one moisture-level sensor and to at least one water tank control unit over a network; a memory on which are stored machine-readable instructions that when executed by the processor, cause the processor to: acquire a moisture-level data from the at least one moisture-level sensor at a plant location, determine a plant type based on the plant location associated with the at least one moisture-level sensor, process the moisture-level data and the plant type to generate an at least one feature vector, provide the at least one feature vector to an artificial intelligence (AI) module for generation of an irrigation instruction output, and responsive to the irrigation instruction output received from the AI module, send a command signal to the at least one water tank control unit to turn on a pump for irrigation of the plant location.

Another embodiment of the present disclosure provides a method for intelligent irrigation that includes one or more of: acquiring a moisture-level data from the at least one moisture-level sensor at a plant location; determining a plant type based on the plant location associated with the at least one moisture-level sensor; processing the moisture-level data and the plant type to generate an at least one feature vector; providing the at least one feature vector to an artificial intelligence (AI) module for generation of an irrigation instruction output; and responsive to the irrigation instruction output received from the AI module, send a command signal to the at least one water tank control unit to turn on a pump for irrigation of the plant location.

Another embodiment of the present disclosure provides a computer-readable medium including instructions for acquiring a moisture-level data from the at least one moisture-level sensor at a plant location; determining a plant type based on the plant location associated with the at least one moisture-level sensor; processing the moisture-level data and the plant type to generate an at least one feature vector; providing the at least one feature vector to an artificial intelligence (AI) module for generation of an irrigation instruction output; and responsive to the irrigation instruction output received from the AI module, send a command signal to the at least one water tank control unit to turn on a pump for irrigation of the plant location.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a diagram of an intelligent irrigation system consistent with the present disclosure;

FIG. 1B illustrates a diagram of an intelligent irrigation system including an artificial intelligence (AI) module consistent with the present disclosure;

FIG. 2 illustrates a diagram of an intelligent irrigation system including detailed features of an irrigation server consistent with the present disclosure;

FIG. 3 illustrates a flowchart of a method for intelligent irrigation consistent with the present disclosure;

FIG. 4 illustrates a further flow chart of a method for intelligent irrigation consistent with the present disclosure; and

FIG. 5 illustrates a block diagram of a system including a computing device for performing the method of FIGS. 3 and 4.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of processing job applicants, embodiments of the present disclosure are not limited to use only in this context.

The present disclosure provides a system, method and computer-readable medium for an intelligent irrigation of multiple plants based on individual moisture-level read at plants’ locations such as individual pots and plant type-based irrigation requirements. Each plant location has a moisture sensor accessible by a cloud irrigation server. The irrigation cloud server processes the moisture-level data received from the moisture-level sensors and may provide this data to user devices such as PCs or smartphones. Then, the user can send an irrigation request to the irrigation cloud server which sends a command (i.e., a control signal) to a control unit of a water tank based on the irrigation request.

The control unit turns on a pump integrated with the water tank that pumps water through a pipe to a particular plant pot based on the request. The request may include multiple plant locations. In one embodiment, the irrigation cloud server may access plant irrigation data from a database that contains recommendations for all available plant types. The irrigation recommendations may be provided to a user device so that the user can generate the irrigation request based on the recommendation. Once the irrigation begins, the irrigation cloud server continues to acquire moisture-level readings from the moisture-level sensors. If the moisture-level specified in the irrigation request is reached for a particular plant location, the irrigation cloud server sends a command to the control unit of the water tank to turn off a pump or to close off the valve for an irrigation pipe leading to the particular plant area. Meanwhile, irrigation of other plants may continue until the moisture-level specified in the irrigation request is detected.

In one embodiment of the present disclosure, the irrigation system provides for an intelligent irrigation based on implementation of an artificial intelligence (AI) module running on the irrigation cloud server. The irrigation cloud server may process the moisture-level data acquired from the moisture-level sensors and may provide the feature vectors based on the moisture-level data to the AI module. The AI module may access the irrigation database and may output comprehensive irrigation recommendation for each of the plants’ locations based on multitude of parameters such as plant type, GEO-location, seasonal data, air temperature, humidity, etc. This data may be additionally collected by the irrigation cloud server using sensors or this data may be acquired from the irrigation database. Then, the irrigation cloud server may send a command to the control unit of the water tank to turn on the pumps to start irrigation for selected plants. This way the intelligent irrigation occurs automatically without user involvement. The irrigation of the particular plants continues until the moisture-level specified in the comprehensive irrigation recommendation for the particular plant is detected from the corresponding moisture sensor at the plant location. In one embodiment, the cloud irrigation server may acquire the water availability from a capacitance-based water-level sensor located in the water tank. The capacitance-based water-level sensor may be configured to measure fluid level in any tank or reservoir. The current water-level data may be also provided to the AI module to be considered for outputting irrigation recommendation data. For example, if the current water level is low, the irrigation levels may be reduced and may be achieved later when the water-level in the tank increases.

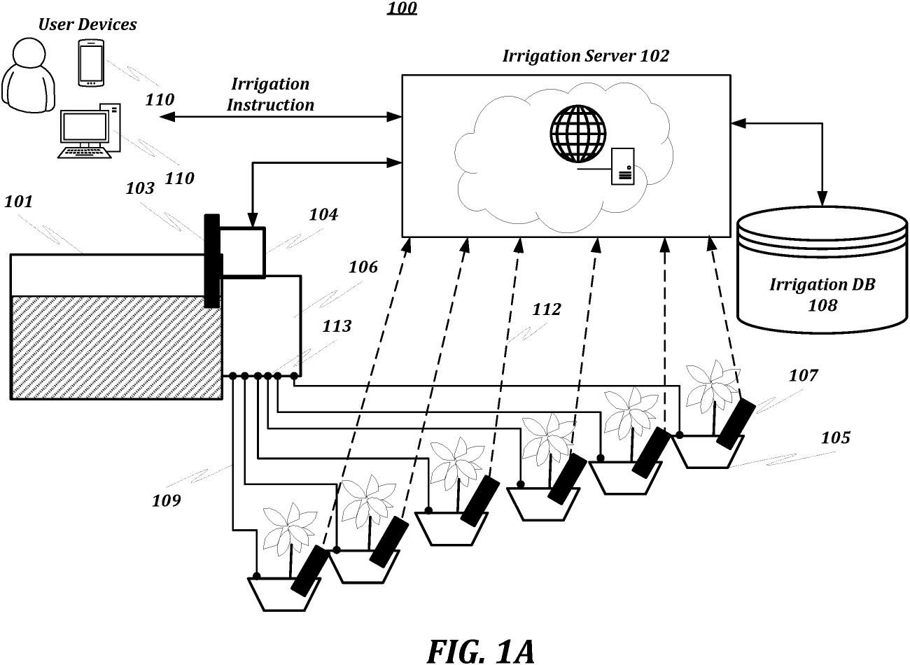

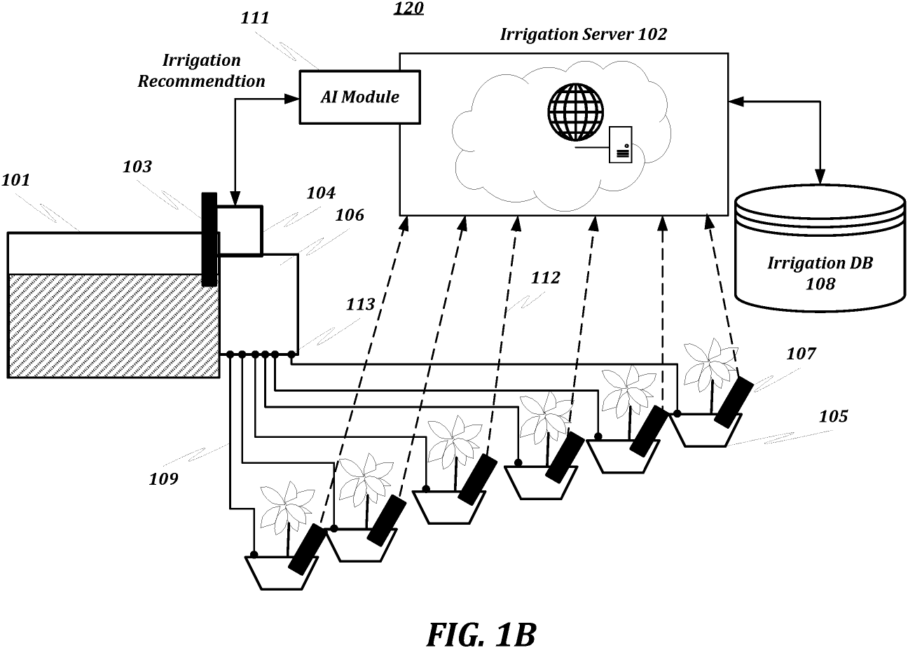

FIG. 1A illustrates a diagram of a system 100 for an intelligent irrigation of multiple plants based on individual moisture-level read at plants’ locations such as individual pots, consistent with the present disclosure.

Referring to FIG. 1A, the example system 100 includes an irrigation server 102 connected to multiple moisture-level sensors 107 over a wireless network. The moisture-level sensors 107 are placed inside the soil inside of respective pots 105. Note that each pot 105 may house a different kind of a plant requiring different level of moisture.

The irrigation cloud server 102 processes the moisture-level data 112 received from the moisture-level sensors 107 and may provide this data to user devices 110 such as PCs or smartphones. Then, a user can send an irrigation request to the irrigation cloud server 102 which sends a command (i.e., a control signal) to a control unit 104 of a water tank 101 based on the irrigation request.

The control unit 104 turns on a pump 113 integrated with the water tank 101 that pumps water through a pipe 109 to a particular plant pot 105 based on the irrigation request specifying the moisture-level for the particular plant pot 105. The irrigation request may include multiple plant locations. In one embodiment, the irrigation cloud server 102 may access plant irrigation data from a database 108 that contains recommendations for all available plant types. The irrigation recommendation(s) may be provided to a user device 110 so that the user can generate the irrigation request based on the recommendation(s). Once the irrigation begins, the irrigation cloud server 102 continues to acquire moisture-level readings 112 from the moisture-level sensors 107.

If the moisture-level specified in the irrigation request is reached for a particular plant location (i.e., a pot 105) the irrigation cloud server 102 sends a command signal to the control unit 104 of the water tank 101 to turn off a pump 106 or to close off a particular valve 113 for an irrigation pipe 109 leading to the particular plant area (i.e., a pot 107) Meanwhile, irrigation of other plants may continue until the moisture-level specified in the irrigation request is detected. In one embodiment, the water tank 101 may be equipped with a water level sensor 103 connected the control unit 104 for providing the water-level readings.

In one embodiment, the moisture-level sensors 107 may include a microcontroller configured to generate an electrical clock signal from the microcontroller instead of using a conventional timer/oscillator. The moisture sensors 107 include two conductive (e.g., copper) strips used as the sensor probe material that is placed inside the soil. For example, these conductive strips can be made of a pure copper sheet with 1.6 mm thickness or simply a PCB of 1.6 mm thickness with 35 µm copper sheet. The width of each copper strip may be from 1 cm to 1.5 cm each and the length may vary according to environmental requirements. The conductive copper strips may be placed at 0.5 cm to 1 cm from each other to create the required capacitance effect. The capacitance is used to determine a current moisture-level. In one embodiment, to prevent the corrosion of the copper strips, the strips can be coated with two materials either an epoxy resin of 5 mm thickness or protected by applying PCB solder mask.

In yet another embodiment, the sensor 107 probe may consist of a conductive copper plate located at the center and a ground plate is configured to go around the center plate. The sensor probe may have two parallel copper layers located on a PCB with 1.6 mm thickness. The thickness of the copper sheet on the PCB may be 40 µmm. The width of the ground layer may be around 3 mm and for a positive layer it may be 7 mm in width. The provided dimensions are recommended for a base model with 30 mm by 70 mm width and length of PCB. Other dimensions may be used depending on the pot sizes. The copper layers may be coated with two materials - an epoxy resin of 5 mm thickness or by application of a PCB solder mask on the strips. Note that any number of moisture sensors 107 may be connected to the irrigation clous server 102.

FIG. 1B illustrates a diagram of an intelligent irrigation system including an artificial intelligence (AI) module consistent with the present disclosure.

Referring to FIG. 1B, the example system 120 includes an irrigation cloud server 102 connected to multiple moisture-level sensors 107 over a wireless network. The moisture-level sensors 107 are placed inside the soil inside of respective pots 105. Note that each pot 105 may house a different kind of a plant requiring different level of moisture.

The irrigation cloud server 102 processes the moisture-level data 112 received from the moisture-level sensors 107. The irrigation cloud server 102 is configured to host an AI module 111. The irrigation cloud server 102 may provide the feature vectors generated based on the moisture-level data 112 to the AI module 111. The AI module 111 may access the irrigation database 108 and may output comprehensive irrigation recommendation for each of the plants’ locations (i.e., pots 105) based on multitude of parameters such as plant type, GEO-location, seasonal data, air temperature, humidity, etc. This data may be additionally collected by the irrigation cloud server 112 using sensors or this data may be acquired from the irrigation database 108 storing some historical data or from other sources.

Then, the irrigation cloud server 102 may send a command signal to the control unit 104 of the water tank 101 to turn on the pump(s) 106 to start the irrigation for selected plants. This way the intelligent irrigation occurs automatically without user involvement. The irrigation of the particular plants continues until the moisture-level data 112 specified in the comprehensive irrigation recommendation for the particular plant is detected from the corresponding moisture-level sensor 107 at the plant location (i.e., a pot 105). In one embodiment, the irrigation cloud server may acquire the water availability from a capacitance-based water-level sensor 103 located in the water tank 101 and connected to the control unit 104. The water-level sensor 103 may be configured to measure a fluid level in any tank or reservoir. The current water-level data may be also provided to the AI module 111 to be considered for outputting irrigation recommendation data. For example, if the current water level is low, the irrigation levels may be temporarily reduced and may be achieved later when the water-level in the tank increases.

As discussed above, the control unit 104 turns on a pump 113 integrated with the water tank 101 that pumps water through a pipe 109 to a particular plant pot 105 based on the irrigation recommendation provided by the AI 111 specifying the moisture-level for the particular plant pot 105. The irrigation request may include multiple plant locations. Once the irrigation begins, the irrigation cloud server 102 continues to acquire moisture-level readings 112 from the moisture-level sensors 107 and may continuously or periodically provide the moisture-level readings 112 to the AI 111 for updated recommendations.

If the moisture-level specified in the irrigation request is reached for a particular plant location (i.e., a pot 105) the irrigation cloud server 102 sends a command signal to the control unit 104 of the water tank 101 to turn off a pump 106 or to close off a particular valve 113 for an irrigation pipe 109 leading to the particular plant area (i.e., a pot 105) Meanwhile, irrigation of other plants may continue until the moisture-level specified in the irrigation recommendation is detected. In one embodiment, the AI module 111 may generate a predictive model(s) based on historical irrigation data stored in the database 108. The AI module 111 may provide predictive outputs data that indicate irrigation levels for various pant types based on current conditions and weather forecasts. Note that the AI module 111 may be implemented on the irrigation clous server node 102 or may be running on a different network node. The AI 111 module may use an underlying neural network.

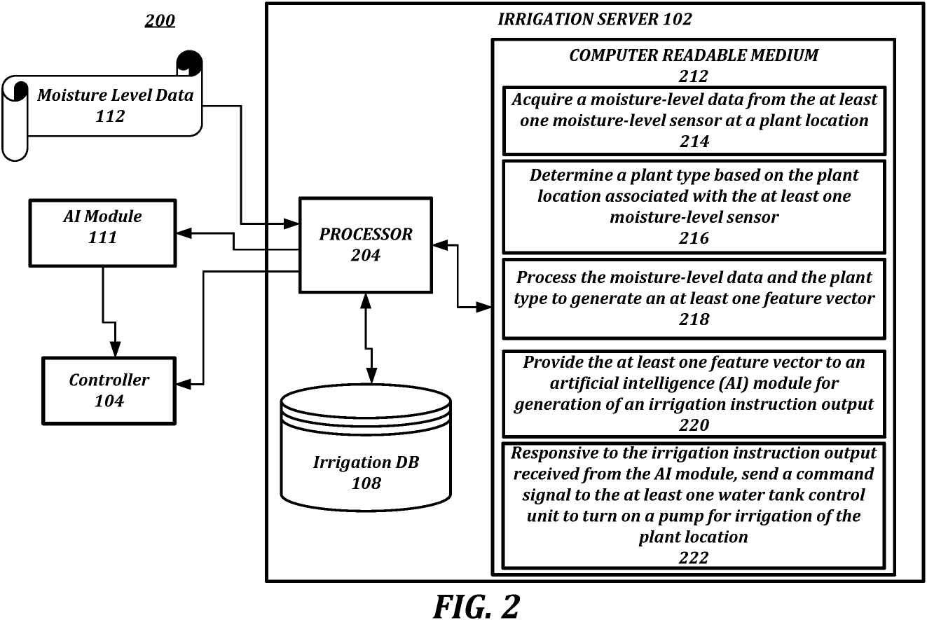

FIG. 2 illustrates a diagram of a system including detailed features of an irrigation server consistent with the present disclosure.

Referring to FIG. 2, the example network 200 includes the irrigation server 102 connected to a controller 104 of a water tank 101 (see FIGS. 1A-B) over a network. The irrigation server 102 may be configured to host or to be connected to an AI module 111. As discussed above with reference to FIGS. 1A-B, the irrigation server 102 may receive moisture-level data 112 from multiple moisture level sensors.

The irrigation cloud server 102 may provide the feature vectors generated based on the moisture-level data 112 to the AI module 111. The AI module 111 may access the irrigation database 108 hosted on the irrigation cloud server 102 and may output comprehensive irrigation recommendation for each of the plants’ locations based on multitude of parameters such as a plant type, plant GEO-location, seasonal data, air temperature, humidity, etc. This data may be additionally collected by the irrigation server 112 using sensors or this data may be acquired from the irrigation database 108 storing some historical data or from other sources. Then, the irrigation server 102 may send a command signal to the control unit 104 of the water tank 101 to turn on the pump(s) to start the irrigation for selected plants as discussed above with respect to FIGS. 1A and B.

While this example describes in detail only one irrigation server 102, multiple such nodes may be connected to an irrigation network. It should be understood that the irrigation server 102 may include additional components and that some of the components described herein may be removed and/or modified without departing from a scope of the irrigation server 102 disclosed herein. The irrigation server 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the irrigation server 102 may include multiple processors, multiple cores, or the like, without departing from the scope of the irrigation server 102 system.

The irrigation server 102 may also include a non-transitory computer readable medium 212 that may have stored thereon machine-readable instructions executable by the processor 204. Examples of the machine-readable instructions are shown as 214-222 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire a moisture-level data from the at least one moisture-level sensor at a plant location. The processor 204 may fetch, decode, and execute the machine-readable instructions 216 to determine a plant type based on the plant location associated with the at least one moisture-level sensor. The processor 204 may fetch, decode, and execute the machine-readable instructions 218 to process the moisture-level data and the plant type to generate an at least one feature vector. The processor 204 may fetch, decode, and execute the machine-readable instructions 222 to provide the at least one feature vector to an artificial intelligence (AI) module for generation of an irrigation instruction output. The processor 204 may fetch, decode, and execute the machine-readable instructions 222 to, responsive to the irrigation instruction output received from the AI module, send a command signal to the at least one water tank control unit to turn on a pump for irrigation of the plant location.

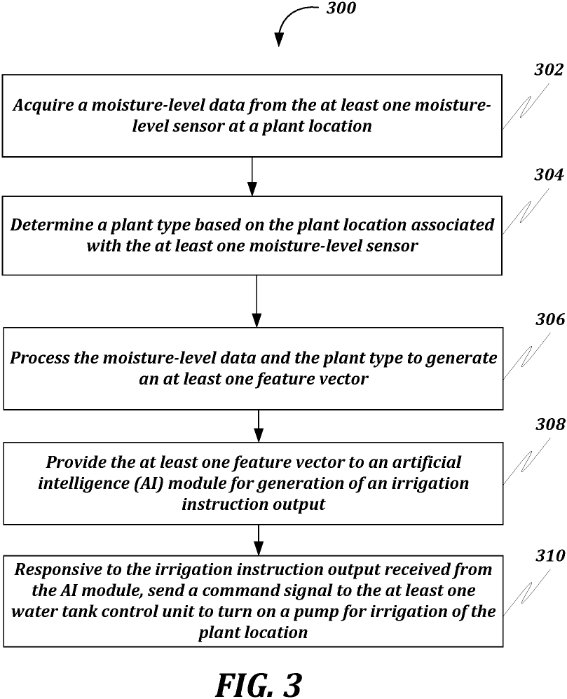

FIG. 3 illustrates a flowchart of a method for intelligent irrigation consistent with the present disclosure.

Referring to FIG. 3, the method 300 may include one or more of the steps described below. FIG. 3 illustrates a flow chart of an example method executed by the irrigation server 102 (see FIG. 2). It should be understood that method 300 depicted in FIG. 3 may include additional operations and that some of the operations described therein may be removed and/or modified without departing from the scope of the method 300. The description of the method 300 is also made with reference to the features depicted in FIG. 2 for purposes of illustration. Particularly, the processor 204 of the irrigation server 102 may execute some or all of the operations included in the method 300.

With reference to FIG. 3, at block 302, the processor 204 may acquire a moisture-level data from the at least one moisture-level sensor at a plant location. At block 304, the processor 204 may determine a plant type based on the plant location associated with the at least one moisture-level sensor. At block 306, the processor 204 may process the moisture-level data and the plant type to generate an at least one feature vector. At block 308, the processor 204 may provide the at least one feature vector to an artificial intelligence (AI) module for generation of an irrigation instruction output. At block 310, the processor 204 may, responsive to the irrigation instruction output received from the AI module, send a command signal to the at least one water tank control unit to turn on a pump for irrigation of the plant location.

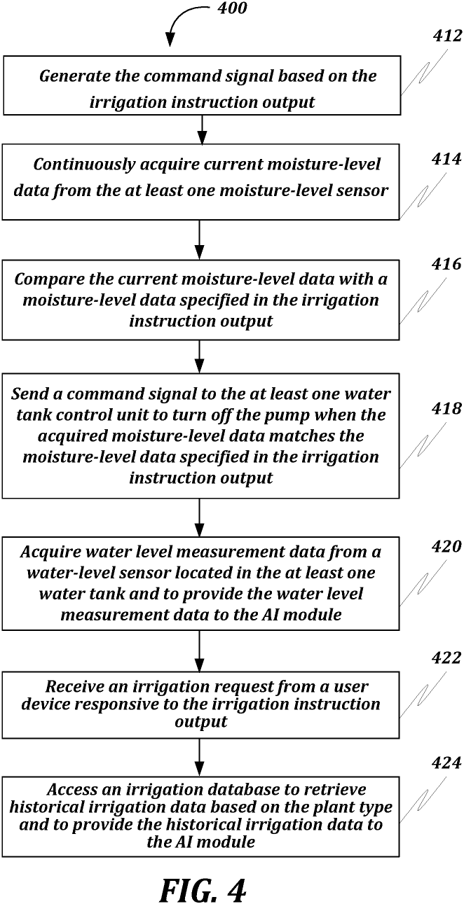

FIG. 4 illustrates a further flowchart of a method for intelligent irrigation consistent with the present disclosure. Referring to FIG. 4, the method 400 may include one or more of the steps described below. FIG. 4 illustrates a flow chart of an example method executed by the irrigation server 102 (see FIG. 2). It should be understood that method 400 depicted in FIG. 4 may include additional operations and that some of the operations described therein may be removed and/or modified without departing from the scope of the method 400. The description of the method 400 is also made with reference to the features depicted in FIG. 2 for purposes of illustration.

Particularly, the processor 204 of the irrigation server 102 may execute some or all of the operations included in the method 400. With reference to FIG. 4, at block 412, the processor 204 may generate the command signal based on the irrigation instruction output. At block 414, the processor 204 may continuously acquire current moisture-level data from the at least one moisture-level sensor. At block 416, the processor 204 may compare the current moisture-level data with a moisture-level data specified in the irrigation instruction output. At block 418, the processor 204 may send a command signal to the at least one water tank control unit to turn off the pump when the acquired moisture-level data matches the moisture-level data specified in the irrigation instruction output. At block 420, the processor 204 may acquire water level measurement data from a water-level sensor located in the at least one water tank and to provide the water level measurement data to the AI module. At block 422, the processor 204 may receive an irrigation request from a user device responsive to the irrigation instruction output. At block 424, the processor 204 may access an irrigation database to retrieve historical irrigation data based on the plant type and to provide the historical irrigation data to the AI module. In one embodiment, the AI module may use an underlying neural network for modeling of irrigation process based on plant types, individual moisture-levels at plant locations, etc. The AI module may use a combination of deterministic formulae as well as machine-learned variable relationships.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

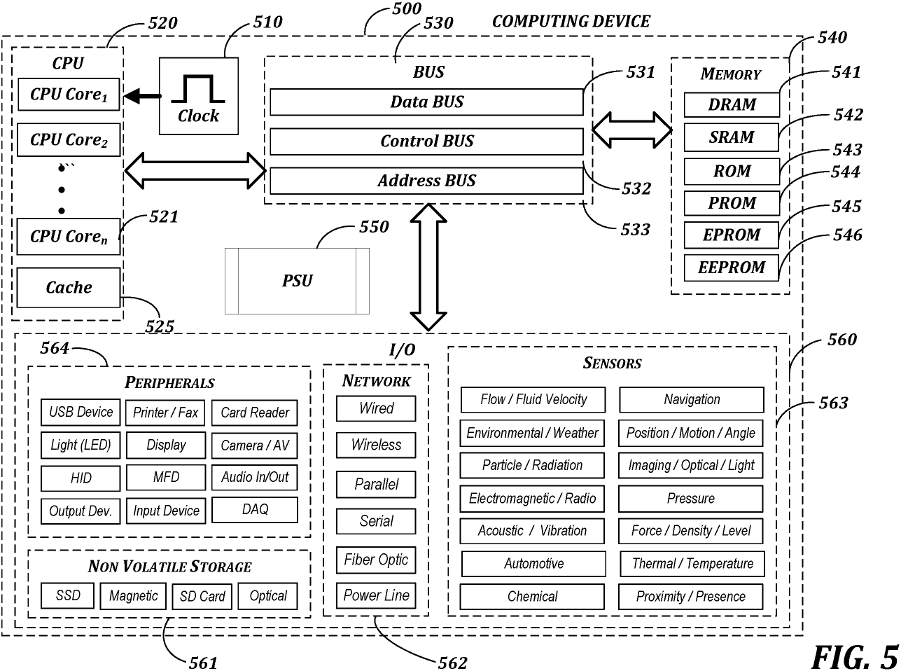

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 400. The computing device 500 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400 / iSeries / System I, A DEC VAX / PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The irrigation server 102 (see FIG. 2) may be hosted on a centralized server or on a cloud computing service. Although method 300 has been described to be performed by the irrigation server node 102 implemented on a computing device 500, it should be understood that, in some embodiments, different operations may be performed by a plurality of the computing devices 600 in operative communication at least one network.

Embodiments of the present disclosure may comprise a computing device having a central processing unit (CPU) 520, a bus 530, a memory unit 540, a power supply unit (PSU) 550, and one or more Input / Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 520, the bus 530, the memory unit 540, a PSU 550, and the plurality of I/O units 560 may be implemented in a computing device, such as computing device 500. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, the memory unit 540, consistent with embodiments of the disclosure.

At least one computing device 500 may be embodied as any of the computing elements illustrated in all of the attached figures, including the irrigation server 102 (FIG. 2). A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

A system consistent with an embodiment of the disclosure the computing device 400 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 500 use a “clock multiplier” which multiplies a lower frequency external clock to the appropriate clock rate of the CPU 520. This allows the CPU 420 to operate at a much higher frequency than the rest of the computer, which affords performance gains in situations where the CPU 520 does not need to wait on an external factor (like memory 540 or input/output 560). Some embodiments of the clock 510 may include dynamic frequency change, where, the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 540, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop / electrical parallel topology, a daisy chain topology, and a connected by switched hubs, such as USB bus. The bus 530 may comprise a plurality of embodiments, for example, but not limited to:
Internal data bus (data bus) 531 / Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
Advanced Technology management Attachment (ATA), including embodiments and derivatives such as, but not limited to, Integrated Drive Electronics (IDE) / Enhanced IDE (EIDE), ATA Packet Interface (ATAPI), Ultra-Direct Memory Access (UDMA), Ultra ATA (UATA) / Parallel ATA (PATA) / Serial ATA (SATA), CompactFlash (CF) interface, Consumer Electronics ATA (CE-ATA) / Fiber Attached Technology Adapted (FATA), Advanced Host Controller Interface (AHCI), SATA Express (SATAe) / External SATA (eSATA), including the powered embodiment eSATAp / Mini-SATA (mSATA), and Next Generation Form Factor (NGFF) / M.2.
Small Computer System Interface (SCSI) / Serial Attached SCSI (SAS)

HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt / Mini DisplayPort, Mobile PCIe (M-PCIe), U.2, and Non-Volatile Memory Express (NVMe) / Non-Volatile Memory Host Controller Interface Specification (NVMHCIS).
Industry Standard Architecture (ISA), including embodiments such as, but not limited to Extended ISA (EISA), PC/XT-bus / PC/AT-bus / PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP) / Mobile High-Definition Link (MHL), Device Firmware Upgrade (DFU), wireless USB, InterChip USB, IEEE 1394 Interface / Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, know to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g., flash memory and Electrically Alterable PROM [EAPROM]), Mask ROM (MROM), One Time Programable (OTP) ROM / Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 400, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 564. The plurality of hardware is used by the at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using intermediate area in the memory 540. The non-volatile storage sub-module 561 does not lose data when power is removed and may be two orders of magnitude less costly than storage used in memory module, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM / CD-R / CD-RW), Digital Versatile Disk (DVD) (DVD-ROM / DVD-R / DVD+R / DVD-RW / DVD+RW / DVD±RW / DVD+R DL / DVD-RAM / HD-DVD), Blu-ray Disk (BD) (BD-ROM / BD-R / BD-RE / BD-R DL / BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be said are networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN / Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency / spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/ sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel /oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection / pyrometer, Gardon gauge, Golay cell, heat flux sensor, microbolometer, microwave radiometer, net radiometer, infrared / quartz / resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 564 comprises ancillary devices uses to put information into and get information out of the computing device 500. There are 3 categories of devices comprising the peripheral sub-module 564, which exist based on their relationship with the computing device 500, input devices, output devices, and input / output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input /output devices perform that perform both input and output functions. It should be understood by a person having ordinary skill in the art that the ensuing are non-limiting embodiments of the aforementioned peripheral sub-module 564:

Input Devices
Human Interface Devices (HID), such as, but not limited to, pointing device (e.g., mouse, touchpad, joystick, touchscreen, game controller / gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user’s requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics / sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system, comprising:
a processor of an irrigation server connected to at least one moisture-level sensor and to at least one water tank control unit over a network;
a memory on which are stored machine-readable instructions that when executed by the processor, cause the processor to:
acquire a moisture-level data from the at least one moisture-level sensor at a plant location,
determine a plant type based on the plant location associated with the at least one moisture-level sensor,
process the moisture-level data and the plant type to generate an at least one feature vector,
provide the at least one feature vector to an artificial intelligence (AI) module for generation of an irrigation instruction output, and
responsive to the irrigation instruction output received from the AI module, send a command signal to the at least one water tank control unit to turn on a pump for irrigation of the plant location.

2. The system of claim 1, wherein the instructions further cause the processor to generate the command signal based on the irrigation instruction output.

3. The system of claim 1, wherein the instructions further cause the processor to continuously acquire current moisture-level data from the at least one moisture-level sensor.

4. The system of claim 3, wherein the instructions further cause the processor to compare the current moisture-level data with a moisture-level data specified in the irrigation instruction output.

5. The system of claim 4, wherein the instructions further cause the processor to send a command signal to the at least one water tank control unit to turn off the pump when the acquired moisture-level data matches the moisture-level data specified in the irrigation instruction output.

6. The system of claim 1, wherein the instructions further cause the processor to acquire water level measurement data from a capacitance-based water-level sensor located in the at least one water tank and to provide the water level measurement data to the AI module.

7. The system of claim 1, wherein the instructions further cause the processor to receive an irrigation request from a user device responsive to the irrigation instruction output.

8. The system of claim 1, wherein the instructions further cause the processor to access an irrigation database to retrieve historical irrigation data based on the plant type and to provide the historical irrigation data to the AI module.

9. A method, comprising:
acquiring, by an irrigation server connected to an at least one water tank control unit, a moisture-level data from the at least one moisture-level sensor at a plant location;
determining, by the irrigation server, a plant type based on the plant location associated with the at least one moisture-level sensor;
processing, by the irrigation server, the moisture-level data and the plant type to generate an at least one feature vector;
providing, by the irrigation server, the at least one feature vector to an artificial intelligence (AI) module for generation of an irrigation instruction output; and
responsive to the irrigation instruction output received from the AI module, sending a command signal to the at least one water tank control unit to turn on a pump for irrigation of the plant location.

10. The method of claim 9, further comprising generating the command signal based on the irrigation instruction output.

11. The method of claim 9, further comprising continuously acquiring current moisture-level data from the at least one moisture-level sensor.

12. The method of claim 11, further comprising comparing the current moisture-level data with a moisture-level data specified in the irrigation instruction output.

13. The method of claim 12, further comprising sending a command signal to the at least one water tank control unit to turn off the pump when the acquired moisture-level data matches the moisture-level data specified in the irrigation instruction output.

14. The method of claim 9, further comprising acquiring water level measurement data from a capacitance-based water-level sensor located in the at least one water tank and providing the water level measurement data to the AI module.

15. The method of claim 9, further comprising receiving an irrigation request from a user device responsive to the irrigation instruction output.

16. The method of claim 9, further comprising accessing an irrigation database to retrieve historical irrigation data based on the plant type and providing the historical irrigation data to the AI module.

17. A non-transitory computer readable medium comprising instructions, that when read by a processor, cause the processor to perform:
acquiring a moisture-level data from the at least one moisture-level sensor at a plant location;
determining a plant type based on the plant location associated with the at least one moisture-level sensor;
processing the moisture-level data and the plant type to generate an at least one feature vector;
providing the at least one feature vector to an artificial intelligence (AI) module for generation of an irrigation instruction output; and
responsive to the irrigation instruction output received from the AI module, sending a command signal to an at least one water tank control unit to turn on a pump for irrigation of the plant location.

18. The non-transitory computer readable medium of claim 17, further comprising instructions, that when read by the processor, cause the processor to generate the command signal based on the irrigation instruction output.

19. The non-transitory computer readable medium of claim 17, further comprising instructions, that when read by the processor, cause the processor to continuously acquire current moisture-level data from the at least one moisture-level sensor and to compare the current moisture-level data with a moisture-level data specified in the irrigation instruction output.

20. The non-transitory computer readable medium of claim 19 further comprising instructions, that when read by the processor, cause the processor to send a command signal to the at least one water tank control unit to turn off the pump when the acquired moisture-level data matches the moisture-level data specified in the irrigation instruction output.
